(19) United States
(12) Patent Application Publication
(10) Pub. No.: US 2005/0155061 A1
(43) Pub. Date: Jul. 14, 2005

(54) Apparatus and method for managing multimedia-based EPG information

(75) Inventor: Hyun-ki Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/978,468

(22) Filed: Nov. 2, 2004

(30) Foreign Application Priority Data
Jan. 13, 2004 (KR) 10-2004-0002376

(51) Int. Cl. H04N 7/173; G06F 13/00; H04N 5/445; G06F 3/00; H04N 7/16

(52) U.S. Cl. 725/44; 725/40; 725/135; 725/45; 725/43

(57) ABSTRACT

A multimedia-based EPG information management apparatus includes a receiving unit for receiving multimedia data or EPG information for the multimedia data. A display unit is included for displaying the multimedia data or the EPG information for the multimedia data. A control unit displays a first layout area having each of field data corresponding to a first field of the EPG information in icons and displays icons in parallel, and also displays a second layout area having data corresponding to a second field of the EPG information corresponding to the first field data on the basis of arrangement in the display unit. The control unit also displays the second layout area when the icon displayed on the first layout area is selected.

### CROSS-REFERENCE TO RELATED APPLICATION

This application claims priority of Korean Patent Application No. 10-2004-0002376, filed on Jan. 13, 2004, in the Korean Intellectual Property Office, the content of which is hereby incorporated herein by reference.

### BACKGROUND OF THE INVENTION

1. Field of the Invention

Apparatuses and methods consistent with the present invention relate to managing multimedia-based Electronic Program Guide (EPG) information and, in particular, to an apparatus and method for managing multimedia-based Electronic Program Guide (EPG) information wherein the EPG information can be effectively managed and searched for by displaying the EPG information provided to a digital TV via a predetermined layout region.

2. Description of the Related Art

Generally, viewers are provided with information on services and events which are currently broadcasted by transmitting supplementary system information such as channel information as well as basic MPEG-2 (Moving Picture Experts Group-2) audio/video (AN) data in order to provide the viewers with more enhanced services. Specifically, the users can obtain various channel information on digital broadcasting using information of an Electronic Program Guide hereinafter referred to as (“EPG”) through which the users are provided with information on programs being currently broadcast or to be broadcast (hereinafter referred to as “EPG information”).

EPG information is transferred with an image/audio signal of terrestrial wave, cable or satellite broadcasting, stored in a memory unit. This information is provided to a predetermined EPG screen which is composed of a grid-shaped EPG frame according to an EPG function selection by the user. Using the EPG information displayed on the EPG screen, the user can determine multimedia program schedules of various channels.

Such an EPG screen may be composed of the grid-shaped EPG frame as shown in FIG. 1, wherein a horizontal axis 210 refers to a time axis which is composed of cell arrays of 3 columns corresponding to different multimedia programs, each cell represents 30 minutes, and a vertical axis 220 refers to a channel axis which is composed of cell arrays of 12 rows listing programs.

Some programs may occupy a cell with two or more columns because of their broadcasting time. If the user wants to obtain broadcasting program information, he or she searches for channel and time on the time axis and the channel axis and moves a cursor from one cell to an adjacent cell so as to select a program.

Such a conventional EPG frame having the grid shape adopts the same scheme as a format of a newspaper or a TV guide brochure as it would be projected on a TV screen without any correction, and is effective for delivering text information. That is, the paper medium is mainly used for delivering static text information while the A/V medium, like a TV display, delivers dynamic information, and thus, it is not effective to use only the static format on TV.

Also, since a user interface of the conventional EPG has the time axis and the channel axis crossing each other, the time axis provides only program information for each channel at a corresponding time and channel axis provides only time information for a corresponding channel, in a limited manner. In other words, since the time axis and channel axis cross each other, it is difficult to provide additional information except the channel and time.

Accordingly, there is a need for a method and apparatus for managing the EPG information in order to simultaneously display two-dimensional static text information and dynamic information by altering the EPG format of the grid-shaped guide.

### SUMMARY OF THE INVENTION

An aspect of the present invention is to provide an attractive and user-interactive EPG information searching means which constructs desired channel or genre EPG information according to a user's preference and to provide a detailed specification of the corresponding channel or genre that the user chooses.

According to an exemplary, non-limiting embodiment of the present invention, provided is a multimedia-based EPG information management apparatus, comprising: a receiving unit for receiving multimedia data or EPG information for the multimedia data; a display unit for displaying the multimedia data or the EPG information for the multimedia data; and a control unit for controlling the display of a first layout area having icons representing field data corresponding to a first field of the EPG information. The icons may be displayed in parallel. The control unit also controls the display of a second layout area having data corresponding to a second field of the EPG information corresponding to the first field data on the basis of arrangement in the display unit, and for displaying the second layout area when an icon displayed on the first layout area is selected.

According to another embodiment of the present invention, there is provided a multimedia-based EPG information management method, comprising the steps of: receiving multimedia data or EPG information for the multimedia data; displaying field data corresponding to a first field of the received EPG information in icons through a first layout area. When an icon displayed in the first layout area is selected, data corresponding to a second field of the EPG information is displayed. The displayed data of the second field of the EPG information corresponds to data of the first field of EPG information.

Preferably, but not necessarily, the EPG information includes a first field composed of channel or genre information of the multimedia data, and a second field composed of program information of a channel or genre corresponding to the first field.

Preferably, but not necessarily, the first layout area is constructed with a multiple stage structure and the second layout area further includes a preview area of the multimedia data.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a schematic diagram illustrating a conventional structure for providing EPG information;

FIG. 2 is a schematic diagram illustrating an apparatus for managing a multimedia-based EPG information in accordance with an exemplary embodiment of the present invention;

FIG. 3 is a schematic flow chart of a method for managing multimedia-based EPG information in accordance with the present invention;

FIGS. 4A and 4B are schematic diagrams illustrating a structure of first and second layout areas in accordance with an exemplary embodiment of the present invention;

FIGS. 5A and 5B are schematic diagrams illustrating structures of a control screen of first and second layout areas in accordance with an exemplary embodiment of the present invention; and

FIGS. 6A to 6C are schematic diagrams showing a layout output in accordance with an exemplary embodiment of the present invention.

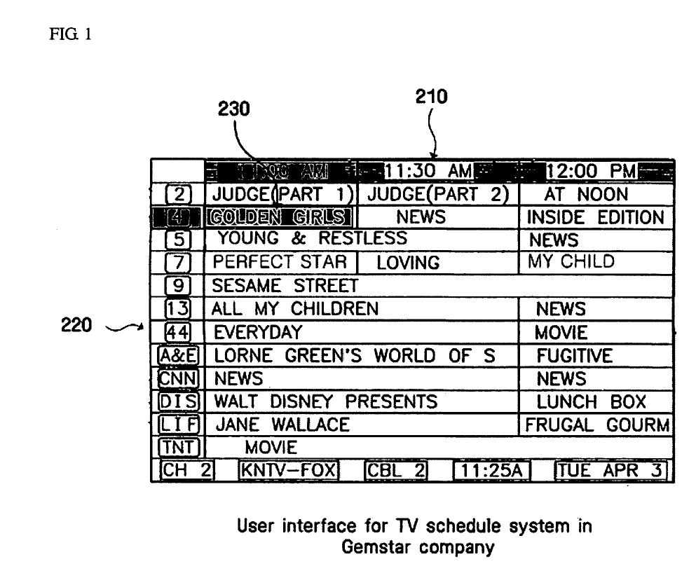

### DETAILED DESCRIPTION OF ILLUSTRATIVE, NON-LIMITING EMBODIMENTS OF THE INVENTION

The present invention will now be described more fully hereinafter with reference to the accompanying drawings, in which exemplary embodiments of the invention are illustrated. This invention may, however, be embodied in different forms and should not be construed as limited to the embodiments set forth herein. Rather, these embodiments are provided so that this disclosure will be thorough and complete, and will fully convey the scope of the invention to those skilled in the art. Same numbers refer to same elements throughout the specification.

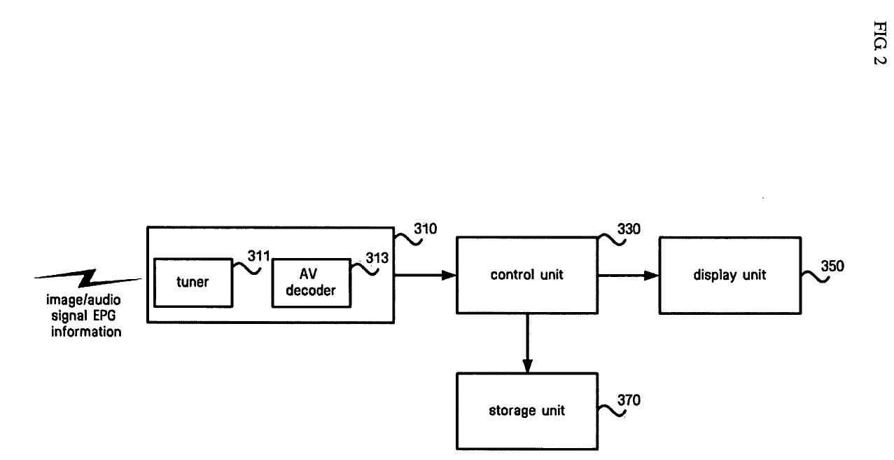

FIG. 2 is a schematic diagram illustrating an apparatus for managing multimedia-based EPG information in accordance with an exemplary embodiment of the present invention.

Referring to FIG. 2, the multimedia-based EPG information management apparatus comprises a receiving unit 310, a control unit 330, a display unit 350 and a storage unit 370.

The receiving unit 310 receives multimedia data or EPG information for the multimedia data, and comprises a tuner 311 for selecting a desired channel and an AV decoder 313 for decoding a signal received from the tuner into audio and video data.

The tuner 311 selects a desired channel signal between a wireless signal input via an antenna (not shown) and a wired signal input via a cable (not shown). Signals input via the wireless or wired medium include audio and video signals, and additionally carry a supplementary signal such as a synchronization signal for system control, and information pertaining to channel/genre for constructing EPG information and a program of each channel/genre.

The AV decoder 313 extracts the A/V signals and program information from the signals of the selected channel received through the tuner 311. The audio and video signals for a digital broadcasting are transmitted after being coded using a compression scheme such as MPEG-2 in order to reduce the quantity of information in most cases, and the AV decoder 313 decodes the coded A/V signals using a predetermined method and restores the A/V data.

The control unit 330 stores the EPG information extracted from the receiving unit 310 in the storage unit 370, and then loads the stored EPG information from the storage unit 370 according to an EPG function, as selected by the user, and constructs an EPG frame for the EPG information.

The EPG information comprises a first field including channel or genre information for the multimedia data, and a second field including program information for a channel or genre, corresponding to the first field.

The EPG frame comprises two layout areas, a first layout area which displays data of the first field of the EPG information as icons and arranges the icons in parallel, and a second layout area which displays data of the second field of the EPG information corresponding to the first field data in response to a user selecting an icon in the first layout area. Although the icons are described as being arranged to be parallel, it will be appreciated that they can be arranged in a different manner. The first layout area is constructed with a multi-stage structure, and three-dimensional icons are arranged in parallel at each stage.

For example, the first layout area is constructed in the form of a multi-stage bookcase, and a book icon is arranged in each stage of the bookcase so that channel and genre information is provided through each book icon.

The parallel arrangement order of the icons is decided through a separate control screen which consists of a channel list and a genre list. The channel list includes channels for multimedia data received via the receiving unit 310 and stage information to display each channel, and the genre list includes genres for the multimedia data received via the receiving unit 310 and display on/off information for each genre.

The second layout area is constructed with a program list of a channel or genre corresponding to an icon of the selected first layout and a preview area of the multimedia data corresponding to each program.

For example, the second layout area is shaped with an opened book selected through the first layout area taking the shape of a bookcase and provides program information and a preview of a desired program through each page.

The control unit 330 can change the grids in width, size or position of the first and second layout areas constituting the EPG frame in accordance with a user's selection, and stores information for configuring the first and second layout areas (referred to as first and second layout information, hereinafter) input through the control screen in the storage unit 370.

The user can select the first and second layout areas using a button of a remote control or a multimedia apparatus, and can change the configuration and size of the first and second layout areas using a remote control or multimedia apparatus.

The display unit 350 controlled by the control unit 330 displays multimedia data or EPG information for the multimedia data. The display unit 350 may be a Cathode Ray Tube (CRT), a Plasma Display Panel (PDP), and a Liquid Crystal Display (LCD), as an example.

The storage unit 370 stores predetermined data according to the operation control of the control unit 330. For this purpose, memory means of RAM such as a DRAM, a SDRAM, a SRAM, or an UtRAM is usually used.

For reference, in the multimedia-based EPG information management apparatus in accordance with an exemplary embodiment of the present invention described above, each of the modules may be comprised entirely of hardware, the whole modules may be comprised of software and hardware, or otherwise the whole modules may solely be comprised of software.

Accordingly, it does not depart from an idea of the present invention that the multimedia-based EPG information management apparatus in accordance with an exemplary embodiment of the present invention is comprised of hardware or software, and modifications and changes can be added without departing from the idea of the present invention since the present invention can be comprised of hardware and software.

The EPG information management method of the present invention using the multimedia-based EPG information management apparatus constructed as described above will be explained in detail with reference to the accompanying drawings.

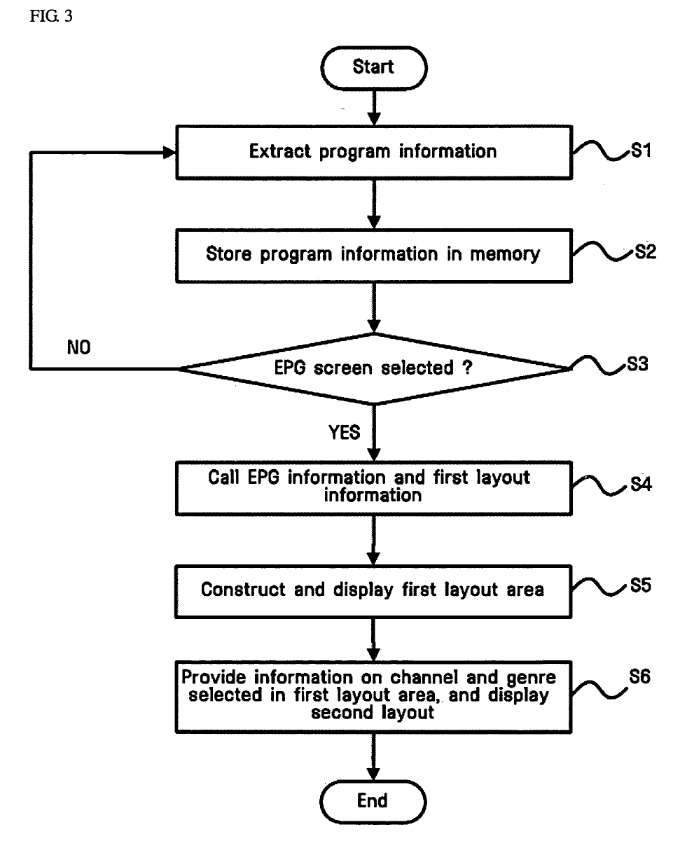

FIG. 3 is a schematic flow chart of a method for managing multimedia-based EPG information in accordance with the present invention.

First, program information is extracted from an input signal transferred via wired or wireless medium in order to display the EPG on screen (S1). The program information is in a text form, indicating a multimedia channel and a program broadcasting time. The extracted program information is stored in a memory so that a user can watch the EPG screen whenever he or she wants to do so (S2). When the user selects the EPG screen by use of a control, which may be remote, to watch the EPG screen (S3), the EPG information and the first and second layout information stored in the storage unit 370 are fetched (S4) and the first layout area is constructed with the EPG information and first layout information so as to be then displayed (S5). The second layout area is constructed with the information that the user selects from the displayed first layout area and provides program information for the selected channel or genre (S6).

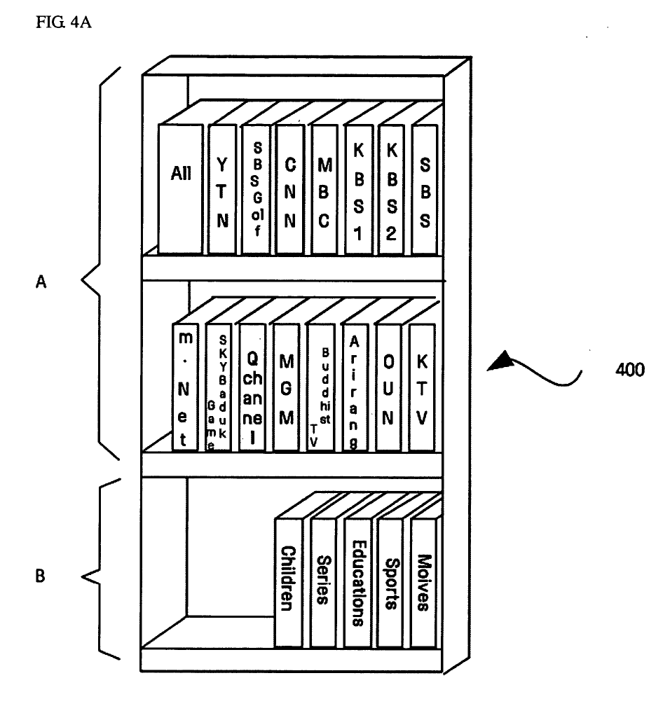

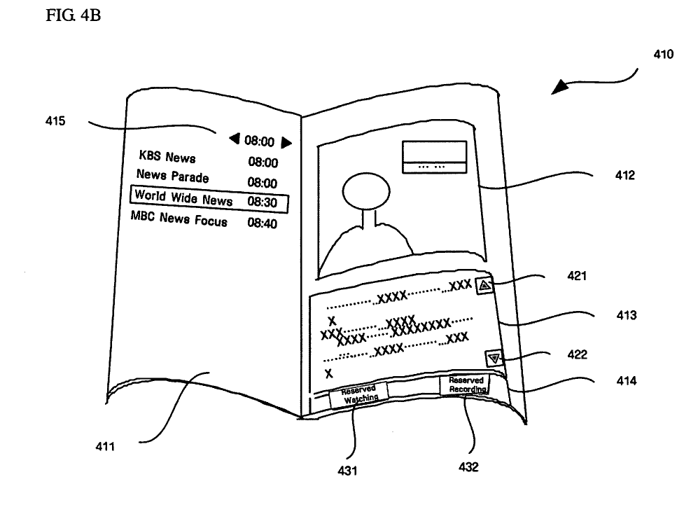

FIGS. 4A and 4B are schematic diagram illustrating structure of first and second layout areas in accordance with an exemplary embodiment of the present invention.

Between the first and second layout areas provided with EPG information in accordance with an exemplary embodiment of the present invention, the first layout area is shaped with a bookcase 400 comprising a channel selection unit A in two stages and a genre selection unit B in one stage.

In the channel selection unit A, book-shaped broadcasting channels selected from a control screen are displayed in parallel, wherein each book-shaped channel is arranged on a stage assigned for arrangement, in an order predetermined through the control screen.

In the genre selection unit B, book-shaped genres selected through the control screen are displayed in parallel, and each book-shaped genre is arranged on a stage assigned for arrangement, in the order predetermined through the control screen.

It has been described that the first layout area comprises the channel selection unit A in two stages and the genre selection unit B in one stage, but this is just by way of example, and the first layout area will not be limited thereto. Rather, the first layout area may be modified or changed in shape according to the number of receivable broadcasting channels and the number of genres to be displayed.

The second layout area is shaped as a book 410 selected through the first layout area as shown in FIG. 4B, and the book 410 is constructed with a first page containing a program list part 411 and a second page including a channel PIP part 412 constituting a preview area, a program description part 413 and a program function part 414.

The program list part 411 includes a program title of the broadcasting channel selected by the user and program broadcasting time information. Here, when the user selects a specific program from the program list part 411 of the first page, various aspects of information on the program are displayed on the program description part 413 of the second page as text information.

The channel PIP part 412 displays an image of the channel which has been displayed before the EPG screen is selected, in accordance with an exemplary embodiment of the present invention, or a moving picture for a simple introduction or preview about the program selected in the first page.

The program description part 413 provides various text information about the program selected by the user. For example, the text information may include a grade, a synopsis, and the cast of a program. A scroll up button 421 and a scroll down button 422 are used to display additional text information.

The program function part 414 provides an indication of reserved watching 431 and reserved recording 432 of a program which is selected by the user in the program list part 411 and displayed on the channel PIP part 412 and described in the program description part 413 of the second page. When the book 410 is displayed, the bookcase 400 may be faded-out.

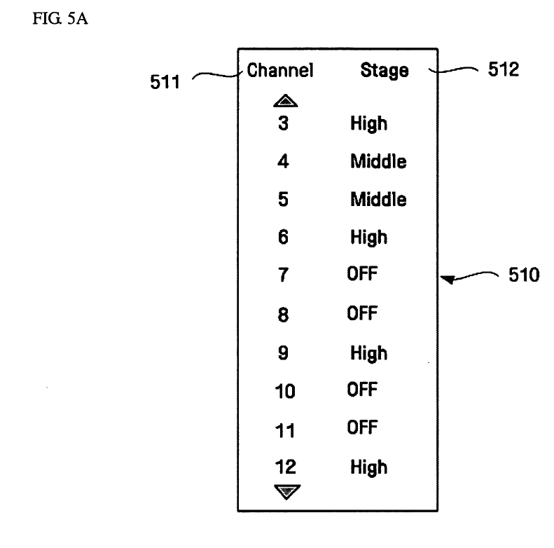

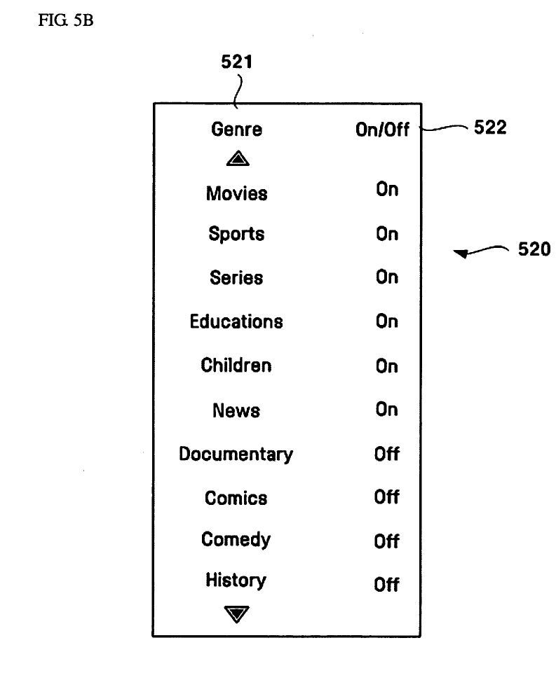

FIGS. 5A and 5B are schematic diagrams illustrating structures of a control screen of a first layout area in accordance with an exemplary embodiment of the present invention.

A control screen for constructing the first layout area generally comprises a control screen for channels and a control screen for genres.

Through the control screen 510 for the channels, a physical position of channel information on a screen display of the first layout area as shown in FIG. 5A may be assigned.

That is, the control screen 510 is constructed with channels 511 for multimedia data received through the receiving unit 310 and stage information 512 to display each of the channels 511.

Such a control screen allows a user to provide input through a predetermined input means, for example, the user searches for a channel by using an up and down direction key and selects a position stage value (high, middle and OFF) for each channel as an input.

Each stage may comprise 10 channels, for example. Initially, channel numbers 1 through 10 are positioned on the top stage of the EPG channel numbers 11 through 20 are positioned on the middle stage thereof, and channel numbers 21 through 30 are in an OFF state before the user inputs the position of a stage. By placing the most favorite channels on the highest position according to a user's watching frequency and physically positioning the most favorite channels different from other broadcasting channels, a visual property of the favorite channels is enhanced and channels which are not watched are removed from the channel selection unit A.

Here, a stage selection range of the control screen 510 is not limited to top, middle and OFF but may be constructed with a plurality of stages and OFF.

The control screen 520 for the genre assigns a physical position of genre information on the screen display of the first layout area, as shown in FIG. 5B.

That is, the control screen 520 is constructed with genres 521 for multimedia data received through the receiving unit 310 and displays on/off information for each of the genres.

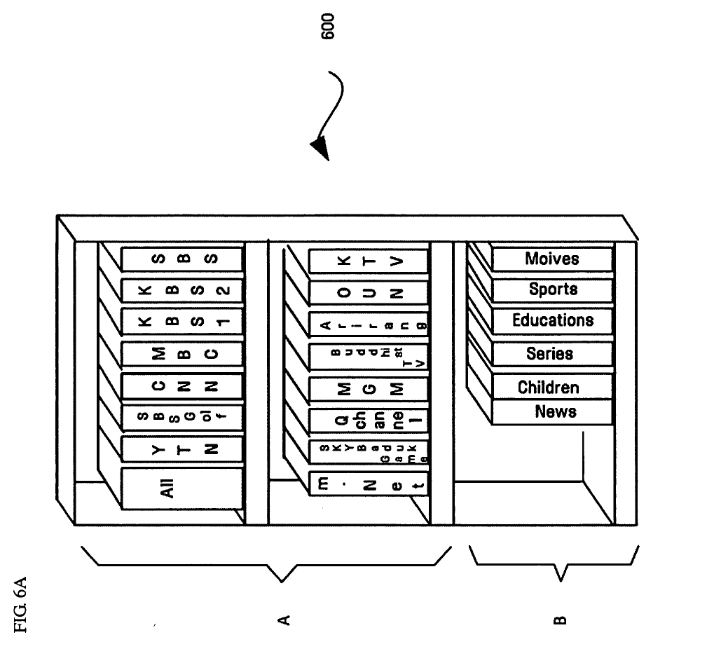

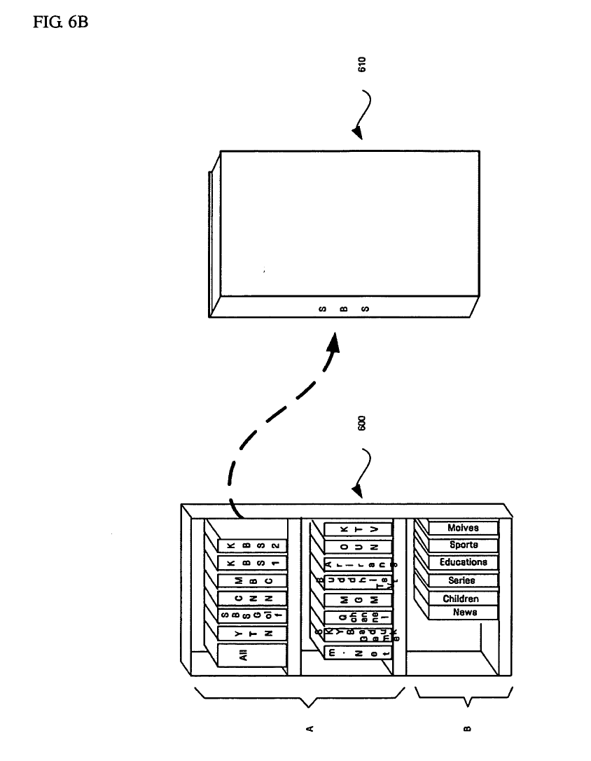

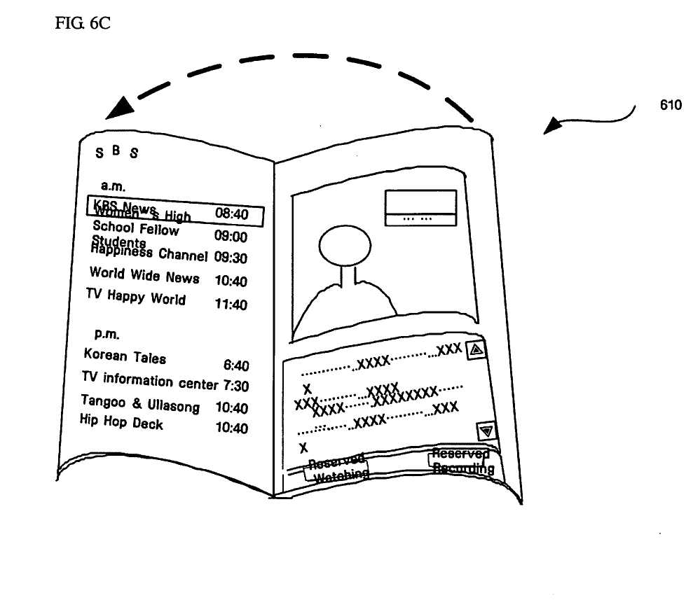

FIGS. 6A to 6C are schematic diagrams showing a layout output in accordance with an exemplary embodiment of the present invention.

By way of an example, when an EPG function is selected by the user, the control unit 330 constructs and displays a first layout area shaped as a bookcase 600 using EPG information and first layout information readout from the storage unit 370, as shown in FIG. 6A.

As shown in FIGS. 6A and 6B, when a bookcase 600 constructed according to a user's preference is displayed, the user selects a book icon 610 corresponding to a specific channel or genre for which the user wishes to obtain more detailed information, from the bookcase 600.

When the user selects a book icon 610 corresponding to an SBS channel, for example, from the high stage of the bookcase 600, the book icon 610 of the SBS channel is taken out from the bookcase and is displayed as shown in FIG. 6B.

When the book icon 610 corresponding to the SBS channel is selected as described above, the control unit 330 provides more detailed EPG information of the selected SBS channel in an opened book form using the readout EPG information, as shown in FIG. 6C.

The user can identify program information and preview programs of the selected SBS channel through first and second pages of the opened book.

According to the present invention constructed as described above, there is an effect that EPG information can be provided by selecting a desired channel or genre according to a user's preference through a control screen.

Also, the EPG information constructed according to the user's preference is provided through the first and second layout areas, and thus it is possible not only to offer a user friendly interface beyond providing simple information, but also offers visual satisfaction and interest as if the user were to be interacting with a paper medium.

As will be appreciated by those skilled in the art, the present invention can be embodied in other concrete forms without changing its technical ideas or essential characteristics. Therefore, it can be understood that the embodiments described above are exemplary in all aspects and not restrictive.

Although exemplary embodiments and drawings of the present invention have been disclosed for illustrative purposes, those skilled in the art will appreciate that various substitutions, modifications, changes and additions are possible, without departing from the scope and spirit of the invention as disclosed in the accompanying claims.

1. A multimedia-based EPG information management apparatus, comprising:
a receiving unit which receives multimedia data or EPG information for the multimedia data, the EPG information having a first field and a second field;
a display unit which displays the multimedia data or the EPG information for the multimedia data; and
a control unit which controls display of,
a first layout area having icons corresponding to data of the first field of the EPG information, and
a second layout area which displays data of the second field of the EPG information corresponding to data of a selected icon in the first layout area,
wherein data of the second layout area is displayed when the icon is selected.

2. The apparatus as claimed in claim 1, wherein the first field includes channel or genre information of the multimedia data, and the second field includes program information of a channel or genre corresponding to the first field.

3. The apparatus as claimed in claim 1, wherein the first layout area is a multiple stage structure.

4. The apparatus as claimed in claim 1, wherein the icons are three-dimensional.

5. The apparatus as claimed in claim 1, wherein a placement order of the icons is determined by a control screen.

6. The apparatus as claimed in claim 5, wherein the control screen comprises a channel list including channels for the multimedia data and stage information for displaying each channel.

7. The apparatus as claimed in claim 5, wherein the control screen comprises a genre list including genres for the multimedia data and display on/off information for each genre.

8. The apparatus as claimed in claim 1, wherein the second layout area further includes a preview area of the multimedia data.

9. A multimedia-based EPG information management method, comprising:
receiving multimedia data or EPG information for the multimedia data;
displaying first field data of the EPG information in icons through a first layout area; and
displaying second field data of the EPG information in a second layout area when an icon displayed in first layout area is selected,
wherein the displayed second field data corresponds to the first field data of the selected icon.

10. The method as claimed in claim 9, wherein the first field data includes channel or genre information of the multimedia data, and the second field data includes program information of a channel or genre corresponding to the first field data.

11. The method as claimed in claim 9, wherein the first layout area is a multiple stage structure.

12. The method as claimed in claim 9, wherein the icons are three-dimensional.

13. The method as claimed in claim 9, wherein the icons are placed in parallel and a placement order is determined through a control screen.

14. The method as claimed in claim 13, wherein the control screen comprises a channel list including channels for the multimedia data and stage information to display the channels.

15. The method as claimed in claim 13, wherein the control screen comprises a genre list including genres for the multimedia data and display on/off information for each genre.

16. The method as claimed in claim 9, wherein the second layout area further includes a preview area of the multimedia data.

17. The apparatus as claimed in claim 1, wherein the icons are placed in parallel to each other in the first layout area.
